(19) United States
(12) Patent Application Publication
(10) Pub. No.: US 2009/0072679 A1
(43) Pub. Date: Mar. 19, 2009

(54) GLASS DOOR FOR REFRIGERATED MERCHANDISER

(75) Inventors: Luis F. Avila, Manlius, NY (US); Mark A. Daniels, Manlius, NY (US); Eugene D. Daddis, JR., Manlius, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: CARRIER CORPORATION, Farmington, CT (US)

(21) Appl. No.: 12/282,714

(22) PCT Filed: Mar. 16, 2006
(86) PCT No.: PCT/US06/09382

§ 371 Date: Sep. 12, 2008

(51) Int. Cl. E06B 5/00; A47F 3/04

(52) U.S. Cl. 312/116; 49/381

(57) ABSTRACT

A thermal insulating glass door includes a multi-panel glass panel assembly having a non-structural, protective trim abutting the peripheral edge of the glass panel assembly and extending along the perimeter of the glass panel assembly, and a pair of hinge brackets mounted to one side of said glass panel assembly in spaced relationship, and a handle on the glass panel assembly on the free-swinging side of the door. The non-structural, protective trim, the handle and the hinge brackets are adhesively bonded to the glass panel assembly using double sided adhesive tape.

### FIELD OF THE INVENTION

This invention relates generally to refrigerated merchandisers, and more particularly, to glass doors for use in commercial refrigerated merchandisers, such as for example, but not limited to, self-service cold beverage display cases, refrigerated food display cases, frozen food display cases, and other merchandisers wherein a product is housed in a chilled product display area for viewing through a glass panel door.

### BACKGROUND OF THE INVENTION

It is long been the practice to merchandise food and beverage products in refrigerated display cases. Conventional refrigerated merchandisers typically comprise a refrigerated, insulated enclosure defining a temperature controlled product display cabinet having one or more glass doors. The temperature of the interior of the product display cabinet is maintained in a desired temperature range, typically within a specified range between 0 degrees F. and 40 degrees F. depending upon the proper storage temperature for the particular product being displayed. Refrigerated merchandisers of this type are commonly found in convenience stores, delicatessens, supermarkets and other retail establishments for displaying products for self-service selection by purchasers, such as meats, poultry, diary products, frozen foods, cold beverages, such as soft drinks, juices, beer, wine coolers, and the like. The products are generally displayed on shelves provided within the temperature controlled interior of the display cabinet between. To select a product for purchase, the customer opens a door to access the interior of the display cabinet and reaches in to retrieve the desired product from the shelf.

Display cabinets used to merchandise food and beverage products customarily employ one or more glass doors through which potential customers may view the product within the display cabinet prior to selection. Most commonly, each glass door is an insulated glass door, typically being of double panel or triple panel construction, surround by a structural frame. For example, U.S. Pat. No. 4,741,127 discloses a double panel insulated glass door having a pair of parallel glass panes disposed in spaced relationship with a metal spacer therebetween for maintaining an air gap between the glass panels sealed by a polysulfide sealant disposed between the glass panels about the periphery of the glass panel. This glass panel assembly is captured in a structural frame for supporting the glass assembly and providing a decorative finished trim about the outer perimeter of the glass assembly. The structural frame is assembled from a plurality of extrusions of aluminum or other suitable metal disposed along the respective sides of the glass panel assembly with a thermal insulating barrier of molded, expanded, or extruded plastic foam material, such as structural foam. A double backed adhesive tape, preferably of a foam type, is provided between the front glass panel and a front leg portion of the thermal insulating barrier, and a strip of similar tape is provided between the front leg portion of the thermal insulating barrier and the inside surface of the front wall of the outer metal frame. A sealing gasket strip is secured to rear side of the thermal barrier on the backside of the frame for providing a seal between the door and the cabinet frame when the door is closed. The door is supported via hinge pins located at the upper and lower corners of one side of the door which are received into associated hinge brackets mounted on the cabinet frame. A handle is mounted to the door's structural frame on the side opposite the hinge pins.

U.S. Pat. Nos. 4,998,382 and 5,024,023 disclose a triple panel insulated glass door having three parallel glass panes disposed in spaced relationship with a metal spacer between each set of neighboring glass panels for maintaining a pair of air gaps between the glass panels sealed by a polysulfide adhesive disposed between the glass panels about the periphery of the glass panel. As with the previously discussed double panel glass door, this glass panel assembly is captured in a structural frame for supporting the glass assembly and providing a decorative finished trim about the outer perimeter of the glass assembly. The structural frame is assembled from a plurality of extrusions of aluminum or other suitable metal disposed along the respective sides of the glass panel assembly. The inner side faces of the structural frame members are in contact with the polysulfide adhesive disposed about the outer periphery of the glass panel assembly. A foam adhesive tape is interposed between a forward side of an inwardly projecting flange of the frame and the rear face of the outer perimeter of the forward glass panel. A sealing gasket strip is provided on the rear side of a plastic moulding supported on the rear side of the outer frame for providing a seal between the door and the cabinet frame when the door is closed. The door is supported via hinge pins located at the upper and lower corners of one side of the door which are received into associated hinge brackets mounted on the cabinet frame. A handle is mounted to the door's structural frame on the side opposite the hinge pins.

Additional examples of conventional insulated glass doors having multiple glass panel assemblies supported in a structural framework extending about the perimeter of the panel assembly are disclosed in U.S. Pat. Nos. 6,318,027; 6,393,768; 6,401,399; 6,606,832; 6,637,093; and U.S. Pat. Appln. Pub. No. 2004/0172892. In an embodiment of a three panel insulated glass door disclosed in U.S. Pat. No. 6,606,832, a forward frame of the structural frame extends inwardly about the glass panel assembly and an insulating or foam tape is adhered to a rearward facing surface of this forward flange and a facing forward surface of the forward glass panel.

Conventional multiple panel glass doors of the type hereinbefore described are necessary heavy due the structural framework of the door which is designed to carry the load of the door. Additionally, from a asetitic viewpoint, the relatively wide structural framework, typically about 2 inches wide, extending around the perimeter of the glass panel assembly overlaps a portion of the glass, thereby masking a portion of the viewing area through the door, and generally detracts from the overall appearance of the door assembly. U.S. Pat. No. 4,637,167 discloses a double panel glass door assembly having a door frame formed of a section capable of supporting the door extending along only the side of the door from which the door is hinged at its upper and lower corners to the cabinet framework. Along its other three sides, the frame is formed from light weight strips of thin stainless sheet metal. A door handle is mounted on the forward glass panel along a side opposite the hinged side of the door. The resultant door still has a structural support member that is a few centimeters wide extending along the entire length of the side of the glass panel assembly from which the door is supported by hinge pins at the upper and lower corners thereof.

Frameless, single panel glass doors are known for use in connection with furniture cabinets, glass enclosures and showers. U.S. Pat. No. 6,164,098 discloses a door handle and latch assembly for a frameless glass having flanges that are biased toward each door to provide an inward acting force to clamp about the side of the frameless glass panel. U.S. Pat. Nos. 4,094,040; 6,381,909; 6,481,055 and 6,766,561, each disclose hinges for use on frameless, single panel glass doors.

### SUMMARY OF THE INVENTION

It is a general object of the present invention to provide a thermal insulating glass door having a lightweight, low-profile non-structural trim.

It is an object of one aspect of the invention to provide a temperature controlled display case having a thermal insulating glass door having a lightweight, low-profile non-structural trim.

It is an object of one aspect of the invention to provide a cold beverage merchandiser having a thermal insulating glass door having a lightweight, low-profile non-structural trim.

In one aspect of the invention, a thermal insulating glass door is provided including a multi-panel glass panel assembly having a non-structural, protective trim abutting the peripheral edge of the glass panel assembly and extending along the perimeter of the glass panel assembly, and a pair of hinge brackets mounted to one side of said glass panel assembly in spaced relationship. The non-structural, protective trim and the hinge brackets are adhesively bonded to the glass panel assembly. A handle may be adhesively bonded to the glass panel assembly on the side thereof opposite the pair of hinge brackets. In an embodiment, the protective trim is bonded to the glass panel assembly by adhesive tape. In an embodiment, the hinge brackets are bonded to the glass panel assembly by adhesive tape. In an embodiment, the handle is bonded to the glass panel assembly by adhesive tape. The glass panel assembly has at least a front glass panel having a front forwardly facing surface and a rear glass panel having a rear rearwardly facing surface, disposed in parallel, spaced relationship with a sealed gap therebetween. In a three panel embodiment of the glass panel assembly, an third glass panel is disposed intermediate the front and rear glass panels and in spaced relationship with each of the front and rear glass panels.

In another aspect of the invention, a refrigerated display case is provided having a refrigerated interior with an opening providing access to the interior, and a glass door supported from the case and having a closed position whereat the glass door closes over the opening, the glass door having a view area through which the refrigerated interior of the display case may be viewed. The refrigerated display case is characterized in that the glass door includes a multi-panel glass panel assembly having a non-structural, protective trim abutting the peripheral edge of the glass panel assembly and extending along the perimeter of the glass panel assembly, and a pair of hinge brackets mounted to one side of said glass panel assembly in spaced relationship. The non-structural, protective trim and the hinge brackets are adhesively bonded to the glass panel assembly. A handle may be adhesively bonded to the glass panel assembly on the side thereof opposite the pair of hinge brackets. In an embodiment, the protective trim is bonded to the glass panel assembly by adhesive tape. In an embodiment, the hinge brackets are bonded to the glass panel assembly by adhesive tape. In an embodiment, the handle is bonded to the glass panel assembly by adhesive tape.

In a further aspect of the invention, a cold beverage merchandiser is provided including a cabinet defining a refrigerated interior and having an opening in a front wall thereof for providing access to the interior of the cabinet, and a glass door supported on hinge members mounted on the cabinet and having a closed position whereat the glass door closes over said opening, the glass door having a view area through which the interior of the cabinet may be viewed. The cold beverage merchandiser is characterized in that the glass door includes a multi-panel glass panel assembly having a non-structural, protective trim abutting the peripheral edge of the glass panel assembly and extending along the perimeter of the glass panel assembly, and a pair of hinge brackets mounted to one side of said glass panel assembly in spaced relationship. The non-structural, protective trim and the hinge brackets are adhesively bonded to the glass panel assembly. A handle may be adhesively bonded to the glass panel assembly on the side thereof opposite the pair of hinge brackets. In an embodiment, the protective trim is bonded to the glass panel assembly by adhesive tape. In an embodiment, the hinge brackets are bonded to the glass panel assembly by adhesive tape. In an embodiment, the handle is bonded to the glass panel assembly by adhesive tape.

### BRIEF DESCRIPTION OF THE DRAWINGS

For a further understanding of these and objects of the invention, reference will be made to the following detailed description of the invention which is to be read in connection with the accompanying drawing, where:

FIG. 1 is a front elevation view of a refrigerated merchandiser having a glass door in accordance with the invention;

FIG. 2 is a front elevation view of a refrigerated display case having a glass door in accordance with the invention;

FIG. 3 is a perspective view of an exemplary embodiment of a multi-panel glass panel assembly in accordance with the invention;

FIG. 4 is a perspective view of another exemplary embodiment of a multi-panel glass panel assembly in accordance with the invention;

FIG. 5 is a cross-section view of a two panel embodiment of the multi-panel glass panel assembly taken along line 5-5 of FIG. 3;

FIG. 6 is a cross-section view of a three panel embodiment of the multi-panel glass panel assembly taken along line 6-6 of FIG. 3;

FIG. 7 is a cross-section view taken along line 7-7 of FIG. 3;

FIG. 8 is a cross-section view taken along line 8-8 of FIG. 4; and

FIG. 9 is a cross-section view taken along line 9-9 of FIG. 4.

### DETAILED DESCRIPTION OF THE INVENTION

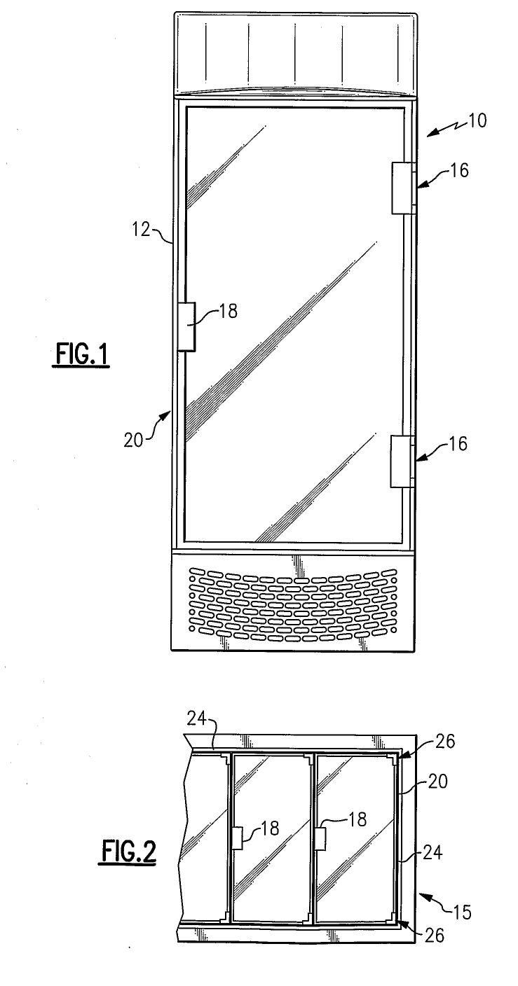

The glass door of the invention may be employed of all manner of refrigerated display cases. Referring now to FIG. 1, a stand-alone refrigerated cold beverage merchandiser 10 is depicted in a single door embodiment equipped with an embodiment of the glass door of the invention. Stand-alone cold beverage merchandisers are commonly used in convenience stores, sandwich stops, delis, cafeterias, grocery stores, and other commercial establishments to display beverages, in cans, bottles or cartons, for self service selection by customers for purchase. The glass door 20 is mounted to the cabinet 12 of the merchandiser 10 by hinges 16 along one side of the door 20. A handle 18 is provided along the opposite side of the door to facilitate opening of the door by customers to access product displayed on shelves (not shown) within the refrigerated interior of the cabinet 12. The glass door of the invention may also be used on multiple door embodiments, typically having either two or three doors, of stand alone cold beverage merchandisers.

The glass door of the invention may also be used on refrigerated display cases of the type commonly used in supermarkets for displaying chilled or frozen foods, including, without limitation, diary cases, ice cream cases, and frozen food cases. In the multiple door display case 15 depicted in FIG. 2, each glass door 20 is mounted by corner hinges 26 to a frame 24 mounted within an opening in a front wall of the display case. Each door 20 is provided with a handle 18 along the opposite side of the door to facilitate opening of the door by customers to access product displayed on shelves (not shown) within the refrigerated interior of the display case 15.

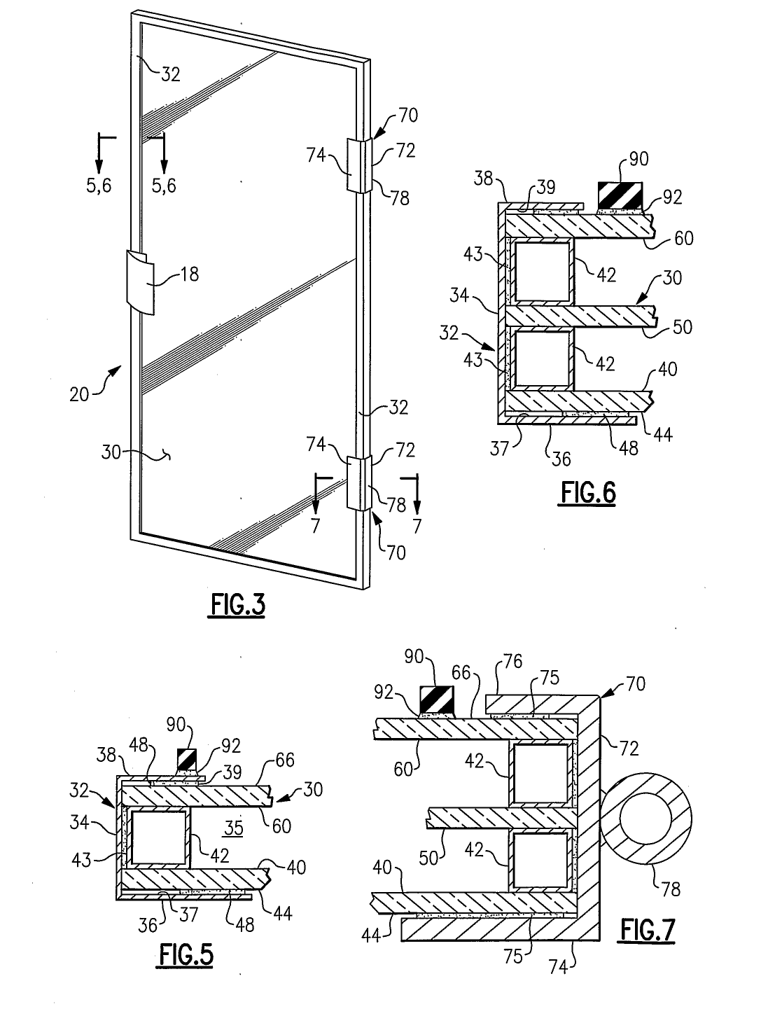

Referring now to FIGS. 3-6, the glass door 20 of the invention is a frameless multi-panel glass door including a multi-panel glass assembly 30 adorned with a lightweight non-structural trim 32. The glass panel assembly 30 comprises a multi-panel glass assembly having at least a front glass panel 40 and a rear glass panel 60 disposed in spaced relationship to provide a gap 35 therebetween, as illustrated in the exemplary embodiment of a two-panel glass depicted in FIG. 5. To further enhance the thermal insulating capability of the glass door, as in conventional practice, an intermediate glass panel 50 may be disposed between and in spaced relationship from each of the front glass panel 40 and the rear glass panel 60 to provide a pair of gaps 35 therebetween, as illustrated in the exemplary embodiment of a three-panel glass depicted in FIG. 6. The front glass panel 40 has a forward facing surface 44 and the rear panel 60 has a rearward facing surface 66. The glass panels are tempered glass panels. The gap or gaps 35 between the glass panels may be an evacuated space or may be filled with an inert gas such as Argon. As in conventional practice, spacers 42 may be provided between the glass panels about the perimeter thereof to maintain the spacing between the glass panels. The spacers 42 may be conventional spacers, for example longitudinally extending members, advantageously of rubber or other elastomeric material, or a metal of relatively low thermal conductively, typically having a rectangular cross-section. A sealant 43, such as for example a polysulfide sealant or other conventional sealant, may be applied about the perimeter of the glass panel to provide a flush surface between the side edges of glass panels and the spacers about the perimeter of the glass panel assembly.

Unlike the structural, load-carrying frames encompassing conventional prior art glass doors, the lightweight, non-structural trim 32 on the multi-panel glass assembly 30 of the glass door 20 does not carrying load. The non-structural trim 32 comprises a lightweight channel, made for example of plastic, aluminum, stainless steel or powder-coated steel or other lightweight material that extends about the perimeter the glass panel assembly 30. The non-structural trim 32 provides a protective backing around the perimeter side faces of the glass panel assembly 30, and also provides a relatively thin border on the forward facing surface 44 of the front panel 40 of the glass panel assembly 30 outlining the perimeter of the glass panel assembly 30 and a similar relatively thin strip on the rearward facing surface 66 of the rear panel 60 of the glass panel assembly 30. The channel may be formed of four channel segments disposed along the respective four sides of the glass panel assembly, or a continuous channel member appropriately bent to turn at the respective corners of the glass panel assembly. The channel has a base 34 that abuts the side faces of the glass panel assembly around the periphery of the glass panel assembly, a forward flange 36 that extends inwardly along the perimeter of the forward facing surface 44 of the front panel 40 of the glass panel assembly 30, and a back flange 38 that extends inwardly along the perimeter of the rearward facing surface 66 of the rear panel 60 of the glass panel assembly 30. The forward flange 36 and back flange 38 provide a strip extending about the perimeter of the respective forward and rear faces of the glass panel assembly. The forward flange 36 extends inwardly for a relatively short extent, for example about ½ inch, to provide a relatively thin border on the front face of the glass panel assembly outlining the perimeter of the glass panel assembly, thereby providing an aesthetically pleasing door having a maximal view area.

The lightweight protective trim 32 is adhesively secured to the glass panel assembly 30. Strips of adhesive tape 48 having adhesive of both sides are provided along the peripheral edges of the forward facing surface 44 of the front glass panel 40. The rearward facing surface of the tape strips 48 are adhesively bonded to the forward facing surface 44 of the front glass panel and the forward facing surface of the tape strips 48 are adhesively bonded to the rearward facing inner surface 37 of the forward flange 36 of the trim channel 32. Additionally, strips of adhesive tape 48 are provided along the peripheral edges of the rearward facing surface 66 of the rear glass panel 60. The forward facing surfaces of the tape strips 48 are adhesively bonded to the rearward facing surface 66 of the rear glass panel 60 and the rearward facing surfaces of the tape strips 48 are adhesively bonded to the forward facing inner surface 39 of the back flange 38 of the trim channel 32. The strips of tape may be commensurate in width to the width of the forward flange and the strips of tape may be commensurate in width to the width of the back flange. The adhesive tape comprises a double adhesive sided, high bond strength adhesive tape such as, for example, VHB™ tape manufactured by 3M Company. By bonding the lightweight protective trim to the glass panel assembly using high bond strength adhesive tape, no penetrations into or through the glass panels are required to accommodate mechanical fasteners, whereby the integrity of the individual glass panels is not compromised.

For providing a seal between the door 20 and the cabinet or case frame for preventing air leakage when the door 20 is in a closed position, a sealing gasket 90 may be provided on the rear face of the door 20 about the perimeter of the door. The sealing gasket 90 may be adhesively bonded by any suitable adhesive material 92, including for example adhesive tape or epoxy, to the rearward facing surface 66 of the rear glass panel 60 of the glass panel assembly 30, such as depicted in FIG. 5, or to the outwardly facing surface of the back channel 38, such as depicted in FIG. 6. The sealing gasket may be any conventional sealing gasket known to those skilled in the art and may contain a magnet or magnetic material for creating a magnetic attraction to the cabinet or case frame.

As noted previously, the glass door 20 is mounted to the refrigerated merchandiser 10 or refrigerated display case 15 for pivotal movement between a closed position and a fully open position. In the embodiment depicted in FIGS. 1 and 3, the glass door 20 is supported from the refrigerated merchandiser 10 on vertically spaced hinges 16. In this embodiment, the glass door 20 includes a pair of hinge brackets 70 mounted in vertically spaced relationship along one side of the door. Each hinge bracket 70 is adapted to mount via a hinge pin (not shown) to and cooperate in a conventional manner with a mating hinge bracket (not shown) mounted to the cabinet or case frame of the merchandiser to form a hinge 16. Referring now to FIG. 7, each hinge bracket 70 comprises a channel-like bracket having an elongated base plate 72, a forward flange 74 extending outwardly from a forward edge of the base plate 72 and a back flange 76 extending outwardly from a back edge of the base plate 72. A tubular member 78, which extends along the outer face of the base plate, is adapted to receive a hinge pin (not shown) when mated in a conventional manner with a corresponding bracket (not shown) of the hinge 16 mounted to the cabinet or case frame. The tubular member 78 may comprise a plurality of axially aligned tubular segments disposed at spaced intervals along the outer face of the base plate 72. The tubular member may be formed integrally with the base plate or may be welded, brazed or otherwise bonded to the base plate. Being a structural load-bearing member, each hinge bracket 70 is made of steel, aluminum or other material of suitable strength.

In the embodiment depicted in FIGS. 2 and 4, the glass door 20 is supported from the refrigerated merchandiser 10 on corner hinges 26. In this embodiment, the glass door 20 includes an upper corner hinge bracket 80 and a lower corner hinge bracket 80 mounted to one side of the door 20 at its upper and lower corners, respectively. Each hinge bracket 80 comprises a channel-like bracket having an elongated angular base plate 82, an L-shaped forward flange 84 extending outwardly from a forward edge of the base plate 82 and an L-shaped back flange 86 extending outwardly from a back edge of the base plate 82. The L-shaped forward flange 84 of the hinge bracket 80 at the upper corner of the door extends along a portion of the top peripheral edge and a portion of the upper side edge of the front panel of the glass panel assembly 30, and the L-shaped back flange 86 of the hinge bracket 80 at the upper corner of the door extends along a portion of the top peripheral edge and a portion of the upper side edge of the rear panel of the glass panel assembly 30. Similarly, the L-shaped forward flange 84 of the hinge bracket 80 at the lower corner of the door extends along a portion of the bottom peripheral edge and a portion of the lower side edge of the front panel of the glass panel assembly 30, and the L-shaped back flange 86 of the hinge bracket 80 at the lower corner of the door extends along a portion of the bottom peripheral edge and a portion of the lower side edge of the rear panel of the glass panel assembly 30. A first hinge pin 83 extends vertically upward from the upper corner hinge bracket 80 and a second hinge pin 85 extends vertically downward from the lower corner hinge bracket 80. To support the glass door from the cabinet or case frame, the upper hinge pin is engaged with a mating receptacle on an associated hinge bracket (not shown) of the upper hinge 26 mounted on the cabinet 10 or the case frame 24 and the lower hinge pin is engaged with a mating receptacle in an associated lower hinge bracket (not shown) of the lower hinge 26 mounted to the cabinet 10 or the case frame 24.

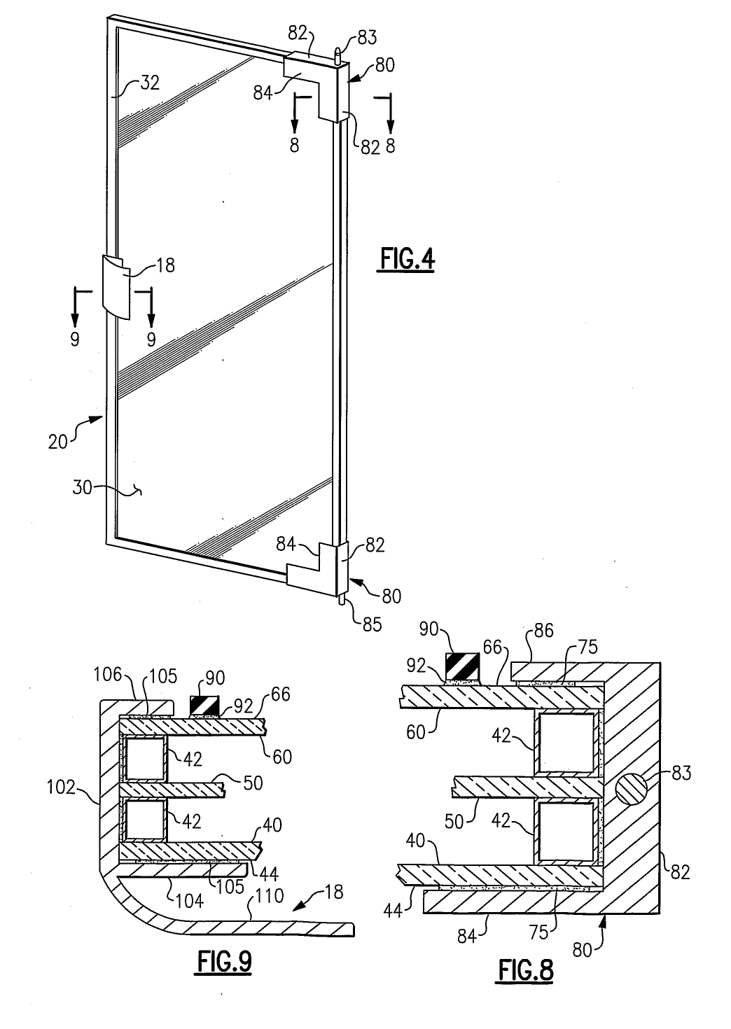

Like the protective trim 20, each hinge bracket 70, 80 is adhesively secured to the glass door assembly. As illustrated in FIGS. 7 and 8, respectively, the glass door assembly is captured between the respective forward flanges 74, 84 and back flanges 76, 86 of the channel-like hinge brackets 70, 80. The protective trim 20 may be deleted along the portion of the glass door assembly captured by the hinge bracket. The respective forward flanges 74, 84 of each hinge bracket 70, 80 may be directly adhesively secured to the front glass panel 40 by a strip 75 of double sided adhesive tape with the rearward side of the tape strip secured to the forward facing surface 44 of the front glass panel 44 and the forward side of the tape strip secured to the inwardly facing surface of the forward flanges 74, 84 of the channel-like hinge brackets 70, 80. Similarly, the respective back flanges 76, 86 of each hinge bracket 70, 80 may be directly adhesively secured to the rear glass panel 60 by a strip 75 of double sided adhesive tape with the forward side of the tape strip secured to the rearward facing surface 66 of the rear glass panel 60 and the rearward side of the tape strip secured to the inwardly facing surface of the back flanges 76, 86 of the channel-like hinge brackets 70, 80.

As previously noted, a handle 18 is mounted to the glass door 20 along the side of the glass door opposite the hinged side. Like the protective trim and the hinge brackets, the handle 18 is adhesively bonded to the glass door. In the embodiment depicted in FIG. 9, the handle 18 comprises a channel-like bracket having an elongated base plate 102, a forward flange 104 extending outwardly from a forward edge of the base plate 18, a back flange 106 extending outwardly from a back edge of the base plate 18, and an additional cupped flange 110 extending forwardly and outwardly from a forward edge of the base plate 102 for facilitating opening of the door 20 by customers to access product (not shown) within the refrigerated merchandiser 10 or refrigerated display case 15. The forward flange 104 of the channel is directly adhesively secured to the forward glass panel 40 by a strip of double sided adhesive tape 105 and the back flange 106 of the channel is similarly directly adhesively secured to the rearward glass panel 60 by a strip 105 of double sided adhesive tape.

In the embodiments of the glass door 20 of the invention discussed hereinbefore, double sided adhesive tape is the adhesive material used to bond the protective trim 32, the hinge brackets 70, 80, and the handle 18 to the glass panel assembly 30. However, is some applications, it may be desirable to use a very high bond strength epoxy as the adhesive material, in particular for bonding the hinge brackets 70, 80, which are structural elements of the door 20, to the glass panel assembly. When using an epoxy as the adhesive material, the surface of the glass panel assembly to which the epoxy is to be applied may be etched or otherwise roughened, to improve the adherence of the epoxy to the glass surface.

While the present invention has been particularly shown and described with reference to the preferred mode as illustrated in the drawing, it will be understood by one skilled in the art that various changes in detail may be effected therein without departing from the spirit and scope of the invention as defined by the claims. For example, the glass door of the invention has application on display cases wherein any product is presented for self-service consumer selection in a temperature controlled environment, whether a refrigerated environment or a heated environment.

We claim:

1. A glass door for a refrigerated display case comprising:
a glass panel assembly having a front glass panel having a front forwardly facing surface and a rear glass panel having a rear rearwardly facing surface, and a spacer assembly maintaining said front glass panel and rear glass panel in parallel, spaced relationship with a sealed gap therebetween, said glass panel assembly having a perimeter and a peripheral outwardly facing edge extending about the perimeter of said glass panel assembly;
a non-structural, protective trim abutting the peripheral edge of said glass panel assembly and extending along the perimeter of said glass panel assembly, said trim adhesively bonded to said glass panel assembly; and
a pair of hinge brackets mounted to one side of said glass panel assembly in spaced relationship, said hinge brackets adhesively bonded to said glass panel assembly.

2. A glass door as recited in claim 1 wherein said non-structural, protective trim is adhesively bonded to said glass panel assembly.

3. A glass door as recited in claim 1 wherein said hinge brackets are adhesively bonded to said glass panel assembly by adhesive tape.

4. A glass door as recited in claim 1 wherein each of said pair of hinge brackets comprises a channel member having a base and a forward flange and a rearward flange extending outwardly from the base, the base having an inwardly facing surface abutting the peripheral edge of said glass panel assembly, the forward flange of said channel member adhesively bonded to the front forward facing surface of the front glass panel and the rearward flange of said channel member adhesively bonded to the rear rearwardly facing surface of the rear glass panel.

5. A glass door as recited in claim 4 wherein each of said pair of hinge brackets is adhesively bonded to said glass panel assembly by a first strip of adhesive tape adhesively bonded to the front forwardly facing surface of the front glass panel and the forward flange of said channel member and a second strip of adhesive tape adhesively bonded to the rear rearwardly facing surface of the rear glass panel and the rearward flange of said channel member.

6. A glass door as recited in claim 1 wherein said pair of hinge brackets are bonded to said glass panel assembly by epoxy.

7. A glass door as recited in claim 1 further comprising a handle mounted to a side of said glass panel assembly opposite said pair of hinge brackets, said handle adhesively bonded to said glass panel assembly.

8. A glass door as recited in claim 7 wherein said handle is adhesively bonded to glass panel assembly by adhesive tape.

9. A display case having a temperature controlled interior and an opening providing access to said interior, and a glass door supported from said case and having a closed position whereat said glass door closes over said opening, said glass door having a view area through which the interior of the display case may be viewed, characterized in that said glass door comprises:
a glass panel assembly having a front glass panel having a front forwardly facing surface and a rear glass panel having a rear rearwardly facing surface, and a spacer assembly maintaining said front glass panel and rear glass panel in parallel, spaced relationship with a sealed gap therebetween, said glass panel assembly having a perimeter and a peripheral outwardly facing edge extending about the perimeter of said glass panel assembly;
a non-structural, protective trim abutting the peripheral edge of said glass panel assembly and extending along the perimeter of said glass panel assembly, said trim adhesively bonded to said glass panel assembly; and
a pair of hinge brackets mounted to one side of said glass panel assembly in spaced relationship, said hinge brackets adhesively bonded to said glass panel assembly and adapted to mate with corresponding hinge members supported by said display case for facilitating pivotal movement of said glass door.

10. A display case as recited in claim 9 wherein said non-structural protective trim is adhesively bonded to said glass panel assembly by adhesive tape.

11. A display case as recited in claim 9 wherein said hinge brackets are adhesively bonded to said glass panel assembly by adhesive tape.

12. A display case as recited in claim 9 wherein said pair of hinge brackets are bonded to said glass panel assembly by epoxy.

13. A display case as recited in claim 9 wherein each of said pair of hinge brackets comprises a channel member having a base and a forward flange and a rearward flange extending outwardly from the base, the base having an inwardly facing surface abutting the peripheral edge of said glass panel assembly, the forward flange of said channel member adhesively bonded to the front forward facing surface of the front glass panel and the rearward flange of said channel member adhesively bonded to the rear rearwardly facing surface of the rear glass panel.

14. A display case as recited in claim 13 wherein each of said pair of hinge brackets is adhesively bonded to said glass panel assembly by a first strip of adhesive tape adhesively bonded to the front forwardly facing surface of the front glass panel and the forward flange of said channel member and a second strip of adhesive tape adhesively bonded to the rear rearwardly facing surface of the rear glass panel and the rearward flange of said channel member.

15. A display case as recited in claim 9 further comprising a handle mounted to a side of said glass panel assembly opposite said pair of hinge brackets, said handle adhesively bonded to said glass panel assembly.

16. A display case as recited in claim 9 wherein said handle is adhesively bonded to glass panel assembly by adhesive tape.

17. A cold beverage merchandiser including a cabinet defining a refrigerated interior and having an opening in a front wall thereof for providing access to the interior of said cabinet, and a glass door supported on hinge members mounted on said cabinet and having a closed position whereat said glass door closes over said opening, said glass door having a view area through which the interior of the cabinet may be viewed, characterized in that said glass door comprises:
a glass panel assembly having a front glass panel having a front forwardly facing surface and a rear glass panel having a rear rearwardly facing surface, and a spacer assembly maintaining said front glass panel and rear glass panel in parallel, spaced relationship with a sealed gap therebetween, said glass panel assembly having a perimeter and a peripheral outwardly facing edge extending about the perimeter of said glass panel assembly;
a non-structural, protective trim abutting the peripheral edge of said glass panel assembly and extending along the perimeter of said glass panel assembly, said trim adhesively bonded to said glass panel assembly; and
a pair of hinge brackets mounted to one side of said glass panel assembly in spaced relationship, said hinge brackets adhesively bonded to said glass panel assembly and adapted to mate in operative association with the hinge members mounted on said cabinet for facilitating pivotal movement of said glass door.

18. A cold beverage merchandiser as recited in claim 17 wherein said non-structural protective trim is adhesively bonded to said glass panel assembly.

19. A cold beverage merchandiser as recited in claim 17 wherein said hinge brackets are adhesively bonded to said glass panel assembly by adhesive tape.

20. A cold beverage merchandiser as recited in claim 17 wherein each of said pair of hinge brackets comprises a channel member having a base and a forward flange and a rearward flange extending outwardly from the base, the base having an inwardly facing surface abutting the peripheral edge of said glass panel assembly, the forward flange of said channel member adhesively bonded to the front forward facing surface of the front glass panel and the rearward flange of said channel member adhesively bonded to the rear reaiwardly facing surface of the rear glass panel.

21. A cold beverage merchandiser as recited in claim 20 wherein each of said pair of hinge brackets is adhesively bonded to said glass panel assembly by a first strip of adhesive tape adhesively bonded to the front forwardly facing surface of the front glass panel and the forward flange of said channel member and a second strip of adhesive tape adhesively bonded to the rear rearwardly facing surface of the rear glass panel and the rearward flange of said channel member.

22. A cold beverage merchandiser as recited in claim 17 wherein said pair of hinge brackets are bonded to said glass panel assembly by epoxy.

23. A cold beverage merchandiser as recited in claim 17 further comprising a handle mounted to a side of said glass panel assembly opposite said pair of hinge brackets, said handle adhesively bonded to said glass panel assembly.

24. A cold beverage merchandiser as recited in claim 17 wherein said handle is adhesively bonded to glass panel assembly by adhesive tape.
